(19) United States
(12) Patent Application Publication
(10) Pub. No.: US 2016/0339772 A1
(43) Pub. Date: Nov. 24, 2016

(54) Car Cover

(71) Applicant: Miguel Acosta, Clearwater, FL (US)

(72) Inventor: Miguel Acosta, Clearwater, FL (US)

(21) Appl. No.: 14/714,953

(22) Filed: May 18, 2015

(51) Int. Cl. B60J 11/04

(52) U.S. Cl. CPC B60J 11/04

(57) ABSTRACT

A vehicle covering providing protection from in adverse environment factors as sun, rain, etc and acting as a “mobile” garage like solution for protecting a vehicle from harsh weather conditions. The vehicle covering for vehicles is provided a plastic box mounted on the roof top of the vehicle which acting as a housing for the cover when the cover is not required. The cover of the invention is provided with a remote to operate the covering system, or apparatus with ease and simplicity. In an embodiment of the current invention, air supply by vacuum enables the placing of the covering sheet over the car. In such arrangement the once the car is covered, the electricity/charge given by the batteries creates a magnetic sheet that is attached to the car and keep it fastened. In order to pull the covering sheet back in the box, the battery is cut off and the vacuum will enable the sucking back of the sheet.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to a novel vehicle covering. More particularly, the present invention relates to “a self-retractable cover for vehicles body”.

(2) Background

From the moment man first built a horseless carriage or paid hard-earned cash to bring home that dream set of wheels, he sought to protect his investment from wear and tear and to keep it “looking like new.” Since a vehicle's surface finish is generally damaged by solar radiation, rain, snow, ice, air- or precipitation-borne corrosive environmental emissions and particulates, and decaying animal (e.g., bird) and plant products, a favored approach has been to cover a vehicle with a protective material. Many designs for protective covers have been suggested and patented. All are cumbersome to use remove or store.

Vehicle is one of the most popular and common methods of transportation today, and is facing to the hash environmental exposures, such as freezing rain, hall, snow, dusts, etc. Even an owner of a vehicle may have a garage at home to park the vehicle inside to protect it from those environmental exposures; it is very difficult to protect the vehicle while parking it outside for shopping, working, etc. In a hash cold weather like snowing and freezing rain, the driver may have to spend much time and effort for clearing the snow or a layer of ice accumulated on the vehicle before driving. If the garage is as mobile as a vehicle, the driver just need to park in the “mobile” garage to avoid such hassle.

There are a number of car covers that have been invented and become available in to the market; however, these car covers available in the markets are not as easy to use. Quite often, it is very hard and time consuming to install the cover by one person. It is also just as hard to uninstall the cover as to install it, and so much trouble to fold the cover and put it away. Thus, it is not suitable to use this type of covers for short time and frequent parking.

Some of the known protective covers are custom-designed to closely fit around the top and sides of a particular make and model of car. This type of cover is generally expensive, takes time and effort to deploy or remove, and fits only the make and models for which it was designed. In addition, it is hard or impossible to enter the vehicle or view its contents while this type of cover is deployed.

There are many kinds of devices relating to coverings for vehicles available on the market now. However, it is hardly to find one which is flexible, convenient and efficient in using. Some of the available devices can cover only small areas of body of the vehicle, a windshield, for instance. Other devices may be quite cumbersome for using and storing. Small coverings are obviously not efficient in regards to the protection of the vehicle from outside conditions, especially the heat of the sun. The difficulty of storage brings an inconvenience in using the device.

Most car covers on the market is a simple plastic sheets deployed manually by the owner of the car. Some of recent car covers are installed inside of the trunk of a car and re-winded automatically by a spring re-winder that also is installed inside thereof. Especially, for bad weather, when it rains or in a snow storm, it is very hard to deploy the cover alone even for an adult man. Meanwhile, some expensive luxury cars are provided with a trunk that opens and closed automatically. However, such automatic trunk system faces its limit when the car cover stored therein is a manually deploying one. It is almost impossible to deploy a car cover when it rains while the owner of the car holds luggage in both of his/her hands. If hails come down just after shopping, there is no way to protect the luxury car from the hail stones with a manually deploying car cover. If with a car cover deploys automatically, it will protect the luxury cars, even in the worst situation. It is purpose of the current application to provide a car cover that comes out of a car's trunk, deploys and restored into the trunk automatically by a simple press of button on remote provided along with the covering assembly.

Accordingly, there is a need for vehicle covering which can protect the vehicle from sun and other harsh climatic conditions. Furthermore, there is a need for a vehicle covering which is easy to put on the vehicle and still easier to retract back into its housing provided on the roof of the vehicle from the exterior.

It is an aspect of the invention to overcome or alleviate a problem of the prior art.

This permits the use of the present invention which enhance the prior art of the vehicle covering assembly to be used conveniently and retracted hack in housing with the same convenience.

The present invention overcomes these shortcomings and provides a new device of covering for vehicle body which is able to use instantly to protect proficiently the vehicle body from external elements such as the heat of sun, corrosion of rain, and the like. Because of features of lightweight and collapsible to a tidy shape, the new device of the present invention is really convenient in using in a manner as easy as we use our familiar umbrellas to shield ourselves from sun or rain.

### SUMMARY OF THE INVENTION

In view of the foregoing, one aspect of the various disclosed embodiments of the present invention is to provide a novel vehicle covering system with an easy retraction mechanism. The vehicle covering system is provided with a remote to maneuver the covering system.

Preferably the vehicle covering addresses, or at least ameliorates, one or more of the problems described above. To this end, the present invention related to a novel vehicle covering, with some unique aspects is disclosed.

The present invention teaches an apparatus for remotely controlling a vehicle cover that extends and retracts the cover automatically.

Accordingly, it is a primary object of the present invention to provide a vehicle covering for vehicles to protect them in adverse weather, sun, rain, etc. and act as a ‘mobile’ garage like solution for protecting a vehicle from harsh weather conditions.

The object of the present invention is to provide a plastic box mounted on the roof is top of the vehicle which acts as a housing for the cover when the cover is not required.

It is still another object of the present invention is to provide a remote to operate the covering system or apparatus with ease and simplicity.

Other objects of the present invention will become apparent from time to time throughout the specification as hereinafter related.

in this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention..

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is an overview of the box with the vehicle covering apparatus according to a preferred embodiment of the present invention.

FIG. 2 is a perspective side view of the vehicle covering apparatus installed on a car in loose position, according to a preferred embodiment of the present invention,

FIG. 3 is a perspective side view of the vehicle covering apparatus installed on a car in tied position, according to a preferred embodiment of the present invention.

### DETAILED DESCRIPTIONS OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification of the present invention can be made and may be desired in certain circumstances, and are part of the present invention. Thus, the following description is provided as illustrative of the principle of the present invention.

Embodiments of the present invention provide a novel vehicle covering apparatus with an automated or self-initiated retraction back system using a remote provided along with. The vehicle covering apparatus of the present invention can be fashioned in any number of different configurations. Accordingly, the specific configurations described herein are illustrative only, and are not intended to represent an exhaustive list of all possible configurations or designs of the present invention.

Embodiments of the method are shown in the figures and discussed below, and it should be understood the operations as presented are exemplary and some operations may be substituted, added, rearranged or removed while still encompassing inventive subject matter. Moreover, it should be understood the order of operations is not to be limited unless explicitly specified herein.

Aspects of the present inventive subject matter are described with reference to the figures provided herein.

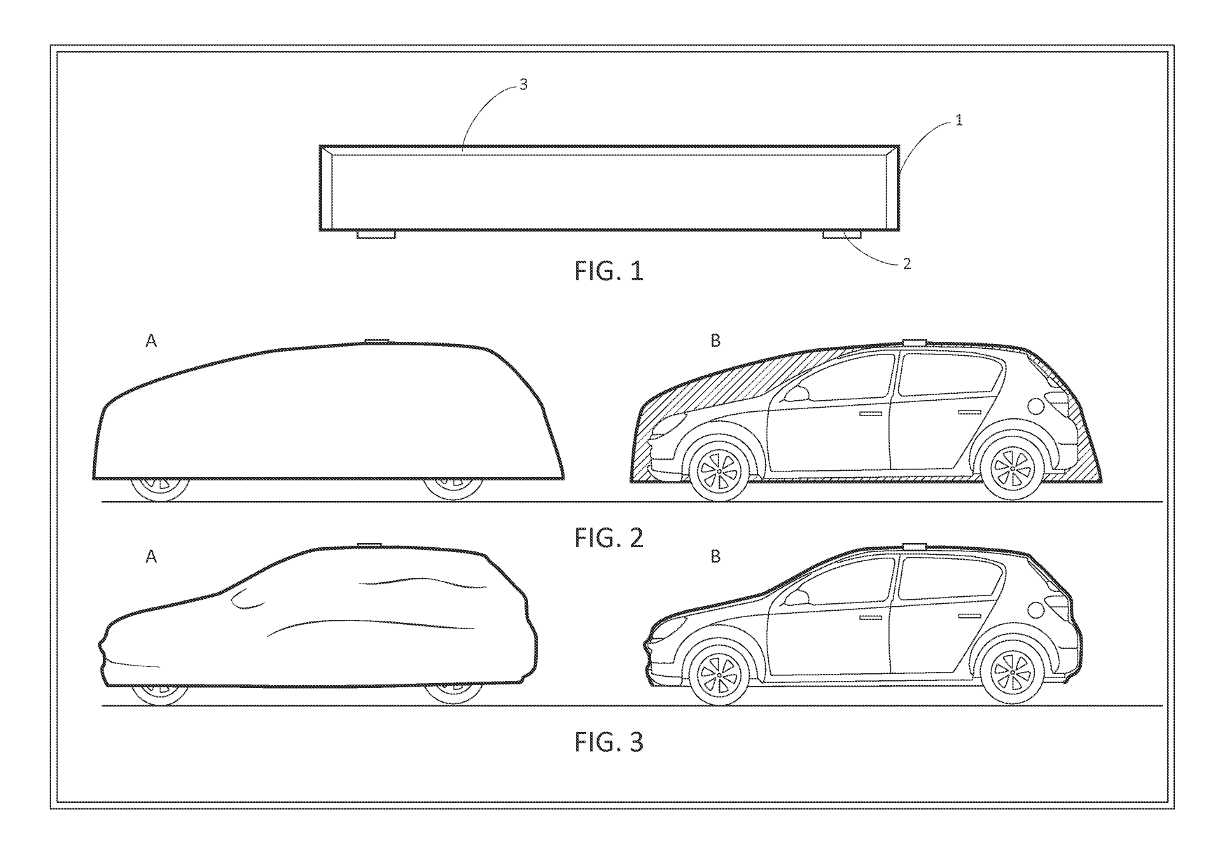

FIG. 1 shows a vehicle covering apparatus according to a preferred embodiment of the present invention. The box 1 provided in the vehicle covering apparatus acts as a housing or storing space for the cover henceforth proposed in the current invention is not in use.

The magnetic or screw-able pieces 2 provided in the vehicle covering apparatus acts as a fastening means for the box for cover henceforth proposed in the current invention is not in use.

The space inside the box 3 provided in the vehicle covering apparatus acts as a housing or storing space for the cover henceforth proposed in the current invention is not in use. The cover, thus proposed in the current invention is a strong plastic sheet.

In one preferred embodiment of the current invention, a set of batteries is provided with the vehicle covering apparatus as discussed. The battery functions to place the covering sheet on the car and to retract it back by cutting of the charge of the battery.

In another preferred embodiment of the current invention, air supply by vacuum enables the placing of the covering sheet over the car. In such arrangement the once the car is covered, the electricity/charge given by the batteries creates a magnetic sheet that is attached to the car and keep it fastened. In order to pull the covering sheet back in the box, the battery is cut off and the vacuum will enable the sucking back of the sheet,

In another preferred embodiment of the current invention, the vehicle covering apparatus is controlled and functioned by using a remote,

As illustrated in FIG. 2A, is a perspective side view of the vehicle covering apparatus installed on a car, according to a preferred embodiment of the present invention. FIG. 2B shows the cross section view of the car protected with the covering apparatus in the loose status. The box is provided on the roof of the vehicle where it ensures proper and effective covering throughout the vehicle.

As illustrated in FIG. 3A and FIG. 3B show a perspective side and cross views accordingly of the vehicle covering apparatus installed on a car in the tied status according to a preferred embodiment of the present invention.

In yet another embodiment of the present invention, a vehicle covering for vehicles is provided to protect them in adverse weather, sun, rain, etc. and act as a “mobile” garage like solution for protecting a vehicle from harsh weather conditions. Also, a vehicle covering for vehicles is provided a plastic box mounted on the roof top of the vehicle which acts as a housing for the cover when the cover is not required. The cover of the invention is provided with a remote to operate the covering system or apparatus with ease and simplicity.

It is to be understood that the above description is intended to be illustrative, and not restrictive. For example, the above discussed embodiments may be used in combination with each other. Many other embodiments will be apparent to those of skill in the art upon reviewing the above description.

Plural instances may be provided for components, operations or structures described herein as a single instance. Finally, boundaries between various components, operations and elements are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fail within the scope of the inventive subject matter,

I claim:

1. A self-retractable covering apparatus for vehicles body acting as a “mobile” garage vehicle to protect vehicles in adverse environmental conditions comprises:
a plastic housing box;
a cover;
a remote operating said cover;
fastening means;
vacuum means;
electric means to place said cover on the car and to retract the cover back; and
covering and retracting means.

2. The self-retractable covering apparatus for vehicles body as claimed in claim 1, wherein said plastic box is mounted on the roof top of the vehicle functioning as said housing for the cover when the cover is not required.

3. A self-retractable covering apparatus for vehicles body as claimed in claim, wherein said remote is used to operate the covering system or apparatus.

4. A self-retractable cover for vehicles body as claimed in claim 1, herein fastening means are magnetic or screw-able pieces.

5. A self-retractable cover for vehicles body as claimed in claim 1, wherein said cover is a durable plastic sheet.

6. A self-retractable cover for vehicles body as claimed in claim 1, wherein said electrical means are batteries.

7. A self-retractable cover for vehicles body as claimed in claim 1, wherein a set of batteries retract said cover by cutting of the charge of the batteries.

8. A self-retractable cover for vehicles body as claimed in claim 1, wherein said vacuum means is vacuum enabling the placing of the covering sheet over the car.

9. A self-retractable cover for vehicles body as claimed in claim 1, wherein retracting of said cover back in said box is obtained by applying said electric and said vacuum means enabling the sucking back of the sheet.

10. A self-retractable cover for vehicles body as claimed in claim 1, wherein said electric means, said vacuum means, and said fastening means maintaining the attachment of said self-retractable cover to the car.
